(19) United States
(12) Patent Application Publication
(10) Pub. No.: US 2021/0056308 A1
(43) Pub. Date: Feb. 25, 2021

(54) NAVIGATION METHOD FOR BLIND PERSON AND NAVIGATION DEVICE USING THE NAVIGATION METHOD

(71) Applicant: TRIPLE WIN TECHNOLOGY(SHENZHEN) CO.LTD., Shenzhen (CN)

(72) Inventor: YU-AN CHO, New Taipei (TW)

(21) Appl. No.: 16/716,831

(22) Filed: Dec. 17, 2019

(30) Foreign Application Priority Data
Aug. 20, 2019 (CN) 201910770229.6

(51) Int. Cl. G06K 9/00; G06T 7/70; G06T 7/593; G06T 7/90

(52) U.S. Cl. CPC G06K 9/00671; G06T 7/70; G06T 2207/10028; G06T 7/90; G06T 7/593

(57) ABSTRACT

A navigation method for blind person and a navigation device using the navigation method are illustrated. The navigation device recognizes images captured around the blind person to determine objects in a road condition, stores the images comprising the road condition and the GPS positions in a database, where the road condition includes a distance between the object and the navigation device along the line of movement of the person, and an azimuth of the detected objects. The navigation device determines the object to be an obstacle or not according to the distance and the azimuth and can output a warning to the blind user as to an obstacle by an output unit.

### CROSS-REFERENCE TO RELATED APPLICATIONS

This application claims priority to Chinese Patent Application No. 201910770229.6 filed on Aug. 20, 2019, the contents of which are incorporated by reference herein.

### FIELD

The subject matter herein generally relates to aids for disabled persons, especially relates to a navigation method for blind person and a navigation device using the navigation method.

### BACKGROUND

In the prior art, the blind can use sensors to sense road conditions. However, navigation functions of such sensors are generally short ranged.

### BRIEF DESCRIPTION OF THE DRAWINGS

Implementations of the present disclosure will now be described, by way of embodiments, with reference to the attached figures.

FIG. 1 is a block diagram of one embodiment of an operating environment of a navigation method.

FIG. 2 illustrates a flowchart of one embodiment of a navigation method of FIG. 1.

FIG. 3 is a block diagram of an embodiment of a navigation device.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The present disclosure, including the accompanying drawings, is illustrated by way of examples and not by way of limitation. Several definitions that apply throughout this disclosure will now be presented. It should be noted that references to “an” or “one” embodiment in this disclosure are not necessarily to the same embodiment, and such references mean “at least one”.

The term “module”, as used herein, refers to logic embodied in hardware or firmware, or to a collection of software instructions, written in a programming language, such as, Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives. The term “comprising” means “including, but not necessarily limited to”; it specifically indicates open-ended inclusion or membership in a so-described combination, group, series, and the like.

Exemplary embodiments of the present disclosure will be described in relation to the accompanying drawings.

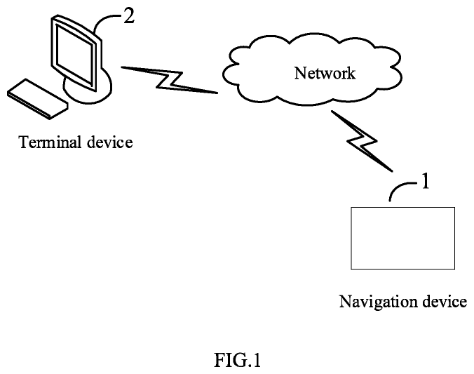

FIG. 1 illustrates an embodiment of an operating environment of a navigation method for blind person. The navigation method runs in a navigation device 1 for blind person. The navigation device 1 communicate with a terminal device 2 by a network. In one embodiment, the network can be a wireless network, for example, the network can be a WI-FI network, a cellular network, a satellite network, or a broadcast network. In one embodiment, the navigation device 1 can be an electronic device with a navigation software, for example, the navigation device 1 can be an AR glass, a smart watch, a smart belt, a smart walking stick, or a smart wearable device.

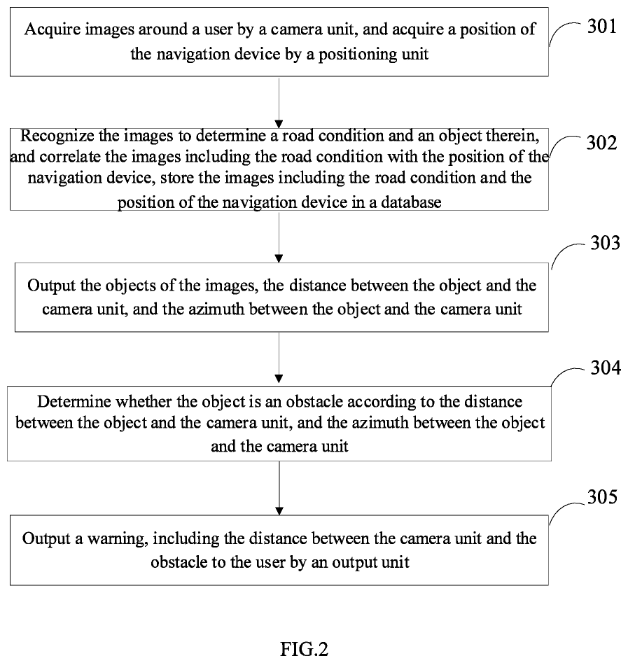

FIG. 2 illustrates the navigation device. In one embodiment, the navigation device 1 includes, but is not limited to, a camera unit 11, a 1 positioning unit 2, an output unit 13, a sensing unit 14, a processor 15, and a storage 16. In one embodiment, the first processor 116 is configured to execute program instructions installed in the navigation device 1. In at least one embodiment, the processor 15 can be a central processing unit (CPU), a microprocessor, a digital signal processor, an application processor, a modem processor, or an integrated processor with an application processor and a modem processor integrated inside. In one embodiment, the storage 16 is configured to store the data and program instructions installed in the navigation device 1. For example, the storage 16 can be an internal storage system, such as a flash memory, a random access memory (RAM) for temporary storage of information, and/or a read-only memory (ROM) for permanent storage of information. In another embodiment, the storage 16 can also be an external storage system, such as a hard disk, a storage card, or a data storage medium. The processor 15 is configured to execute program instructions installed in the navigation device 1.

In one embodiment, the storage 16 stores collections of software instructions, which are executed by the processor 15 of navigation device 1 to perform functions of following modules. The function modules include an acquiring module 101, a recognizing module 102, an output module 103, a determining module 104, and a reminding module 105. In another embodiment, the acquiring module 101, the recognizing module 102, the output module 103, the determining module 104, and the reminding module 105 are a program segment or code embedded in the processor 15 of the navigation device 1.

The acquiring module 101 acquires images around a user by the camera unit 11, and acquires a position of the navigation device 1 by the positioning unit 12. In one embodiment, the camera unit 11 can be a 3D camera, for example, the camera unit 11 can be a 360-degree panoramic 3D camera. In one embodiment, the positioning unit 12 can be a GPS device. The acquiring module 101 acquires the position of the navigation device 1 by the GPS device.

The recognizing module 102 recognizes the images to determine a road condition and an object therein, and correlates the images including the road conditions with the position of the navigation device 1, stores the images including the road conditions and the position of the navigation device 1 in a database. The road conditions include distances between objects and the camera unit 11, and azimuths between the object and the camera unit 11.

In one embodiment, the acquiring module 101 acquires three-dimensional images by the 3D camera. The recognizing module 102 recognizes the road condition from the three-dimensional images includes: splitting each of the three-dimensional images into a deep image and a two-dimensional image, recognizing an object of the two-dimensional image, and calculating the distance between the object and the 3D camera, and the azimuth between the object and the 3D camera by a time of flight (TOF) calculation. In one embodiment, the recognizing module 102 compresses the images including the road condition by an image compression method, correlates the images including the road conditions with the position of the navigation device 1, stores the images including the road conditions and the position of the navigation device 1 in the database. In one embodiment, the image compression method includes, but is not limited to, an image compression method based on MPEG4 encoding, and an image compression method based on H.265 encoding.

In one embodiment, the three-dimensional images include color information and depth information of each pixel, and the recognizing module 102 integrates the color information of each pixel of the three-dimensional images into the two-dimensional image, and integrates the depth information of each pixel of the three-dimensional images into the depth image. The recognizing module 102 can recognize an object of the two-dimensional image by an image recognition method, and calculates a distance between the object and the 3D camera, and the azimuth between the object and the 3D camera by the TOF calculation. In one embodiment, the image recognition method can be an image recognition method based on a wavelet transformation, or a neural network algorithm based on deep learning.

The output module 103 outputs images of the objects, the distances between the objects and the camera unit 11, and the azimuths between the object and the camera unit 11.

For example, the distance between the object and the camera unit 11 output by the output module 103 can be 8 meters (m), and the azimuth between the object and the camera unit 11 output by the output module 103 can be 10 degrees with the object being located in front of and to the right of the camera unit 11.

The determining module 104 determines whether the object is an obstacle according to the distance between the object and the camera unit 11, and the azimuth between the object and the camera unit 11.

In one embodiment, the object can be an obstacle, including, but not limited to, a vehicle, a pedestrian, a tree, a step, or a stone. In one embodiment, the determining module 104 analyzes the user's line of movement track according to the location from the positioning unit 12, determines a direction based on the distance between the object and the camera unit 11, and the azimuth between the object and the camera unit 11, determines an angle between the user's movement track and the direction, determines whether the angle between the user's movement track and the direction is less than a preset angle, and determines that the object is an obstacle when the angle between the user's movement track and the direction is less than the preset angle. In one embodiment, the preset angle can be 15 degrees.

The reminding module 105 outputs a warning, including the distance between the camera unit 11 and the obstacle, to the user by the output unit 13. In one embodiment, the output unit 13 can be a voice announcer or a vibrator device.

In one embodiment, the reminding module 105 searches a first road condition of a target location which is within a preset distance from the user from the database, and prompts the user to re-plan his line of movement when the first road condition reveals obstacles or roads that are not suitable for the user, by the output unit 13. In one embodiment, the preset distance can be 50 m or 100 m. In one embodiment, the roads not suitable for the blind user are waterlogged, icy, or gravel-covered roads. In one embodiment, the sensing unit 14 of the navigation device 1 can sense an unknown object having a sudden appearance around the user, and warn the user as to the unknown object by the voice announcer or the vibrator when the unknown object is sensed. In one embodiment, the unknown object can include a falling rock, or a vehicle bearing down on the user.

In one embodiment, the reminding module 105 acquires a second road condition of the target location which is within the preset distance from the user by the camera unit 11, determines whether the second road condition is identical with the first road condition, and stores the second road condition of the target location in the database to replace the first road condition. For example, the reminding module 105 can search the first road condition of the target location which is 60 m away from the camera unit 11 from the database, and determine that the first road condition includes a rock on the user's road, and, in acquiring the second road condition of the target location by the camera unit 11, determine that the rock no longer exists in the second road condition. The second road condition of the target location is stored in the database to replace the first road condition.

In one embodiment, the reminding module 105 receives a second target location input by the user, acquires a current location by the positioning unit 12, calculates a path between the second target location and the current location according to an electronic map, acquires the road condition from the database, determines whether the path is suitable for the user according to the road condition, and warns the user when the path is not suitable for the user.

In one embodiment, the reminding module 105 calculates the path between the second target location and the current location by a navigation path optimization algorithm. In one embodiment, the navigation path optimization algorithm includes, but is not limited to, a Dijkstra algorithm, an A-star algorithm, a highway hierarchies algorithm. In one embodiment, the path is not suitable for the user when frequent puddles and uneven surfaces exist along the path between the second target location and the current location.

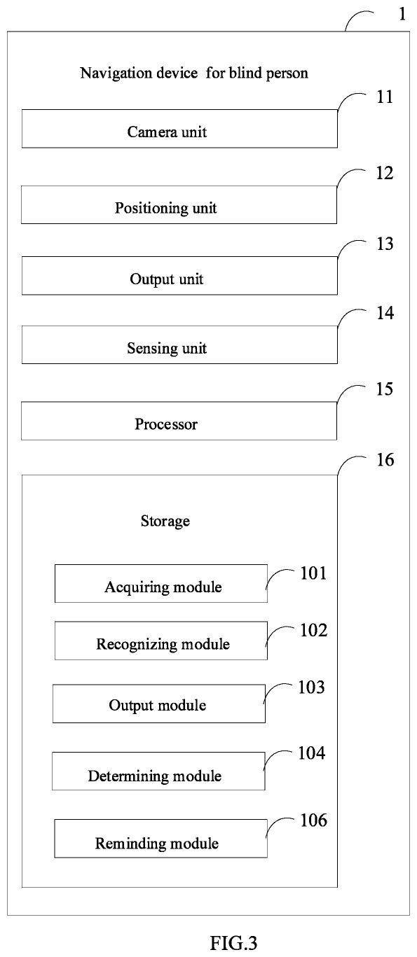

FIG. 3 illustrates a flowchart of one embodiment of a navigation method for blind person. The method is provided by way of example, as there are a variety of ways to carry out the method. The method described below can be carried out using the configurations illustrated in FIGS. 1-2, for example, and various elements of these figures are referenced in explaining the example method. Each block shown in FIG. 3 represents one or more processes, methods, or subroutines carried out in the example method. Furthermore, the illustrated order of blocks is by example only and the order of the blocks can be changed. Additional blocks may be added or fewer blocks may be utilized, without departing from this disclosure. The example method can begin at block 301.

At block 301, a navigation device acquires images around a user by a camera unit, and acquires a position of the navigation device by a positioning unit. In one embodiment, the camera unit can be a 3D camera, for example, the camera unit can be a 360-degree panoramic 3D camera. In one embodiment, the positioning unit can be a GPS device. The navigation device acquires the position of the navigation device by the GPS device.

At block 302, the navigation device recognizes the images to determine a road condition and an object therein, and correlates the images including the road condition with the position of the navigation device, stores the images including the road condition and the position of the navigation device in a database. The road condition includes a distance between the object and the camera unit, and azimuth between the object and the camera unit.

In one embodiment, the navigation device acquires three-dimensional images by the 3D camera. The navigation device recognizes the road condition from the three-dimensional images includes: splitting each of the three-dimensional images into a deep image and a two-dimensional image, recognizing an object of the two-dimensional image, and calculating the distance between the object and the 3D camera, and the azimuth between the object and the 3D camera by a time of flight (TOF) calculation. In one embodiment, the navigation device compresses the images including the road condition by an image compression method, correlates the images including the road condition with the position of the navigation device, stores the images including the road condition and the position of the navigation device in the database. In one embodiment, the image compression method includes, but is not limited to an image compression method based on MPEG4 encoding, and an image compression method based on H.265 encoding.

In one embodiment, the three-dimensional images include color information and depth information of each pixel, and the navigation device integrates the color information of each pixel of the three-dimensional images into the two-dimensional image, and integrates the depth information of each pixel of the three-dimensional images into the depth image. The navigation device recognizes an object of the two-dimensional image by an image recognition method, and calculates a distance between the object and the 3D camera, and the azimuth between the object and the 3D camera by the TOF calculation. In one embodiment, the image recognition method can be an image recognition method based on a wavelet transformation, or a neural network algorithm based on deep learning.

At block 303, the navigation device outputs the objects of the images, the distance between the object and the camera unit, and the azimuth between the object and the camera unit.

For example, the distance between the object and the camera unit output by the navigation device can be 8 meters (m), and the azimuth between the object and the camera unit output by the navigation device can be 10 degree with the object being located in front of and to the right of the camera unit 11.

At block 304, the navigation device determines whether the object is an obstacle according to the distance between the object and the camera unit, and the azimuth between the object and the camera unit.

In one embodiment, the object can be an obstacle including, but not limited to a vehicle, a pedestrian, a tree, a step, or a stone. In one embodiment, the navigation device analyzes the user's line of movement track according to the location from the positioning unit, determines a direction based on the distance between the object and the camera unit, and the azimuth between the object and the camera unit, determines an angle between the user's track line of action and the direction line, determines whether the angle between the user's movement track and the direction is less than a preset angle, and determines the object is an obstacle when the angle between the user's movement track and the direction is less than the preset angle. In one embodiment, the preset angle can be 15 degrees.

At block 305, the navigation device outputs a warning, including the distance between the camera unit and the obstacle to the user by an output unit. In one embodiment, the output unit can be a voice announcer or a vibrator device.

In one embodiment, the navigation device searches a first road condition of a target location which is within a preset distance from the user from the database, and prompts the user to re-plan his line of movement when the first road condition reveals obstacles or roads that are not suitable for the user by the output unit. In one embodiment, the preset distance can be 50 m or 100 m. In one embodiment, the roads not suitable for the user are the roads on which there are waterlogged, icy, or gravel-covered roads. In one embodiment, the sensing unit of the navigation device is used to sense an unknown object having a sudden appearance around the user, and remind the user the unknown object by the voice announcer or the vibrator when the unknown object is sensed. In one embodiment, the unknown object can include a falling rock, or a vehicle bearing down on the user.

In one embodiment, the method further includes: the navigation device acquires a second road condition of the target location which is within the preset distance from the user by the camera unit, determines whether the second road condition is identical with the first road condition, and stores the second road condition of the target location in the database to replace the first road condition. For example, the navigation device can search the first road condition of the target location which is 60 m away from the camera unit from the database, and determine that the first road condition includes a rock on the user's road, and, in acquiring the second road condition of the target location by the camera unit, and determine that the second road condition doesn't exist the rock, and stores the second road condition of the target location in the database to replace the first road condition.

In one embodiment, the method further includes: the navigation device receives a second target location input by the user, acquires a current location by the positioning unit, calculates a path between the second target location and the current location according to an electronic map, acquires the road condition from the database, determines whether the path is suitable for the user according to the road condition, and warns the user when the path is not suitable for the user.

In one embodiment, the navigation device calculates the path between the second target location and the current location by a navigation path optimization algorithm. In one embodiment, the navigation path optimization algorithm includes, but is not limited to a Dijkstra algorithm, an A-star algorithm, a highway hierarchies algorithm. In one embodiment, the path is not suitable for the user when frequent puddles and uneven surfaces exist along the path between the second target location and the current location.

In one embodiment, the modules/units integrated in the navigation device can be stored in a computer readable storage medium if such modules/units are implemented in the form of a product. Thus, the present disclosure may be implemented and realized in any or part of the method of the foregoing embodiments, or may be implemented by the computer program, which may be stored in the computer readable storage medium. The steps of the various method embodiments described above may be implemented by a computer program when executed by a processor. The computer program includes computer program code, which may be in the form of source code, object code form, executable file or some intermediate form. The computer readable medium may include any entity or device capable of carrying the computer program code, a recording medium, a USB flash drive, a removable hard disk, a magnetic disk, an optical disk, a computer memory, a rad-only memory (ROM), random access memory (RAM), electrical carrier signals, telecommunication signals, and software distribution media.

The exemplary embodiments shown and described above are only examples. Even though numerous characteristics and advantages of the present disclosure have been set forth in the foregoing description, together with details of the structure and function of the present disclosure, the disclosure is illustrative only, and changes may be made in the detail, including in matters of shape, size and arrangement of the parts within the principles of the present disclosure, up to and including the full extent established by the broad general meaning of the terms used in the claims.

What is claimed is:

1. A navigation device comprising:
a camera unit;
a positioning unit;
a processor connected to the camera unit, and the positioning unit; and
a non-transitory storage medium coupled to the processor and configured to store a plurality of instructions, which cause the navigation device to:
acquire images by the camera unit, and acquires a position of the navigation device by the positioning unit;
recognize the images to determine a road condition and an object therein, and correlate the images comprising the road condition with the position of the navigation device;
store the images comprising the road condition and the position of the navigation device in a database, wherein the road condition comprises a distance between the object and the camera unit, and an azimuth between the object and the camera unit;
output the object of the images, the distance between the object and the camera unit, and the azimuth between the object and the camera unit; determine whether the object is an obstacle according to the distance between the object and the camera unit, and the azimuth between the object and the camera unit; and
output a warning, the warning comprising the distance between the camera unit and the obstacle by an output unit.

2. The navigation device according to claim 1, wherein the plurality of instructions are further configured to cause the navigation device to:
search a first road condition of a target location which is within a preset distance from the camera unit from the database, and generate a prompt to re-plan lines of movement when the first road condition is determined to have obstacles by the output unit.

3. The navigation device according to claim 2, wherein the plurality of instructions are further configured to cause the navigation device to:
acquire a second road condition of the target location which is within the preset distance from the camera unit by the camera unit, wherein the second road condition is not existing obstacles;
determine whether the second road condition is identical with the first road condition; and
store the second road condition of the target location in the database to replace the first road condition.

4. The navigation device according to claim 1, wherein the plurality of instructions are further configured to cause the navigation device to:
receive a second target location input by an input device of the navigation device;
acquire a current location of the navigation device by the positioning unit;
calculate a path between the second target location and the current location according to an electronic map;
acquire the road condition from the database;
determine whether the path is suitable according to the road condition; and
generate a warning when the path is not suitable.

5. The navigation device according to claim 1, wherein the camera unit is a 3D camera.

6. The navigation device according to claim 5, wherein the plurality of instructions are further configured to cause the navigation device to:
acquire three-dimensional images by the 3D camera;
split each of the three-dimensional images into a deep image and a two-dimensional image;
recognize an object in the two-dimensional image;
calculate a distance between the object in the two-dimensional image and the 3D camera, and the azimuth between the object and the 3D camera by a time of flight calculation.

7. The navigation device according to claim 6, wherein the three-dimensional image comprises color information and depth information of each pixel of the three-dimensional image, the plurality of instructions are further configured to cause the navigation device to:
integrate the color information of each of the pixels of the three-dimensional image into the two-dimensional image, and integrate the depth information of each of the pixels of the three-dimensional image into the depth image.

8. A navigation method for blind person comprising:
acquiring images by a camera unit, and acquiring a position of a navigation device by a positioning unit;
recognizing the images to determine a road condition and an object therein, and correlating the images comprising the road condition with the position of the navigation device, storing the images comprising the road condition and the position of the navigation device in a database, wherein the road condition comprises a distance between the object and the camera unit, and an azimuth between the object and the camera unit;
outputting the object of the images, the distance between the object and the camera unit, and the azimuth between the object and the camera unit;
determining whether the object is an obstacle according to the distance between the object and the camera unit, and the azimuth between the object and the camera unit; and
outputting a warning, the warning comprising the distance between the camera unit and the obstacle by an output unit.

9. The navigation method according to claim 8 further comprising:
searching a first road condition of a target location which is within a preset distance from the camera unit from the database, and generate a prompt to re-plan lines of movement when the first road condition is determined to have obstacles by the output unit.

10. The navigation method according to claim 9 further comprising:
acquiring a second road condition of the target location which is within the preset distance from the camera unit by the camera unit, wherein the second road condition is not existing obstacles;
determining whether the second road condition is identical with the first road condition; and
storing the second road condition of the target location in the database to replace the first road condition.

11. The navigation method according to claim 8 further comprising:
receiving a second target location input by an input device of the navigation device;
acquiring a current location of the navigation device by the positioning unit;
calculating a path between the second target location and the current location according to an electronic map;
acquiring the road condition from the database;
determining whether the path is suitable according to the road condition; and
generate a warning when the path is not suitable.

12. The navigation method according to claim 8, wherein the camera unit is a 3D camera.

13. The navigation method according to claim 12 further comprising:
acquiring three-dimensional images by the 3D camera;
splitting each of the three-dimensional images into a deep image and a two-dimensional image;
recognizing an object in the two-dimensional image;
calculating a distance between the object in the two-dimensional image and the 3D camera, and the azimuth between the object and the 3D camera by a time of flight calculation.

14. The navigation method according to claim 13 further comprising:
integrating color information of each of pixels of the three-dimensional image into the two-dimensional image, and integrating depth information of each of the pixels of the three-dimensional image into the depth image.

15. A non-transitory storage medium having stored thereon instructions that, when executed by at least one processor of a navigation device for blind person, causes the least one processor to execute instructions of a navigation method for blind person, the navigation method comprising:
acquiring images by a camera unit, and acquiring a position of a navigation device by a positioning unit;
recognizing the images to determine a road condition and an object therein, and correlating the images comprising the road condition with the position of the navigation device, storing the images comprising the road condition and the position of the navigation device in a database, wherein the road condition comprises a distance between the object and the camera unit, and an azimuth between the object and the camera unit;
outputting the object of the images, the distance between the object and the camera unit, and the azimuth between the object and the camera unit;
determining whether the object is an obstacle according to the distance between the object and the camera unit, and the azimuth between the object and the camera unit; and
outputting a warning, the warning comprising the distance between the camera unit and the obstacle by an output unit.

16. The non-transitory storage medium as recited in claim 15, wherein the navigation method for blind person is further comprising:
searching a first road condition of a target location which is within a preset distance from the camera unit from the database, and generate a prompt to re-plan lines of movement when the first road condition is determined to have obstacles by the output unit.

17. The non-transitory storage medium as recited in claim 16, wherein the navigation method is further comprising:
acquiring a second road condition of the target location which is within the preset distance from the camera unit by the camera unit, wherein the second road condition is not existing obstacles;
determining whether the second road condition is identical with the first road condition; and
storing the second road condition of the target location in the database to replace the first road condition.

18. The non-transitory storage medium as recited in claim 15, wherein the navigation method is further comprising:
receiving a second target location input by an input device of the navigation device;
acquiring a current location of the navigation device by the positioning unit;
calculating a path between the second target location and the current location according to an electronic map;
acquiring the road condition from the database;
determining whether the path is suitable according to the road condition; and
generate a warning when the path is not suitable.

19. The non-transitory storage medium as recited in claim 18, wherein the navigation method is further comprising:
acquiring three-dimensional images by a 3D camera;
splitting each of the three-dimensional images into a deep image and a two-dimensional image;
recognizing an object in the two-dimensional image;
calculating a distance between the object and the 3D camera, and the azimuth between the object and the 3D camera by a time of flight calculation.

20. The non-transitory storage medium as recited in claim 19, wherein the navigation method is further comprising:
integrating color information of each of pixels of the three-dimensional image into the two-dimensional image, and integrating depth information of each of the pixels of the three-dimensional image into the depth image.
